(19) United States
(12) Patent Application Publication
(10) Pub. No.: US 2005/0042325 A1
(43) Pub. Date: Feb. 24, 2005

(54) Injection molding machine

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,728

(22) Filed: Aug. 19, 2003

(51) Int. Cl. B29C 45/64

(52) U.S. Cl. 425/594

(57) ABSTRACT

An injection molding machine includes a stationary wall for a first mold part to be secured thereto, a movable wall for a second mold part to be secured thereto, and oil cylinders for displacing the movable wall relative to the stationary wall with; the oil cylinders are secured to one side of the stationary wall at tube portions with output rods thereof being projected from the other side of the stationary wall and connected to the movable wall to replace conventional guiding rods; each oil cylinder has a piston, and a subsidiary rod having substantially the same diameter as the output rods; each piston has first and second sides; the output rods are connected to the first sides of the pistons; the subsidiary rods are connected to the second sides of the pistons and can pass through caps of the cylinder tube portions; thus, both sides of each piston have the same area.

### BACKGROUND OF THE INVENTION

1. Field of the invention

The present invention relates to an injection molding machine, more particularly one, which is made in such a manner that mold closing oil cylinders thereof are secured to a stationary wall with actuating rods being projected from cylinder bodies as well as the stationary wall and connected to a movable wall, and such that each of the mold closing oil cylinders has a subsidiary rod, which is connected to the piston and projected from the cylinder body in a direction opposite the actuating rod; thus, the injection molding machine can perform mold closing and mold opening processes without the use of conventional guiding rods or rear fixed walls, and both sides of each of the pistons of the mold closing oil cylinders have the same area due to the subsidiary rods.

2. Brief Description of the Prior Art

Injection molding machines can be generally grouped into upright ones, and horizontal ones. Referring to FIG. 7, a conventional injection molding machine 2 of horizontal type has a main support 21, a material feeding mechanism 22 on one end of the main support 21, a heating tube 23 next to the material feeding mechanism 22, a stationary wall 24 next to the heating tube 23, a movable wall 25 opposing the stationary wall 24 and supported by guiding rods 28, a rear fixed wall 27 on the other end of the main support 21, and a mold closing oil cylinder 26 connected to both the movable wall 25 and the rear fixed wall 27; two parts of a mold 29 are respectively secured to the walls 24 and 25; thus, the movable wall 25 can be moved along the guiding rods 28 for closing and opening the mold 29 by means of the oil cylinder 26.

Referring to FIG. 8, a conventional injection molding machine 3 of upright type has a power source 31, a stationary wall 33, a movable wall 36, a mold closing oil cylinder 34, and subsidiary oil cylinders 35 connected to the walls 33 and 36; two parts of a mold 37 are respectively secured to the walls 33 and 36; thus, the movable wall 33 can be moved up and down for opening and closing the mold 37 by means of the oil cylinders 34 and 35.

Rubber piston rings of the above mold closing oil cylinders 26, 34 will be rubbed against the tube portions of the cylinders, and prone to wear when the cylinders are functioning to move the movable walls, causing increase to maintenance cost.

Referring to FIG. 9, U.S. Pat. No. 4,645,443 discloses an injection molding machine of horizontal type, in which a mold closing oil cylinder is fixed to a tail end of a rear fixed wall, and an actuating rod projects from a first end of a tube portion of the oil cylinder, and is connected to a movable wall for displacing the movable wall; the first end of the tube portion allows the piston to be closely fitted in, and is slightly smaller than other portions of the tube portion in bore diameter such that leakage is prevented, and enough pressure is secured at the end of mold closing process when the piston is within the first end of the cylinder tube portion. In other words, the bore diameter of the cylinder tube portion is slightly bigger than the diameter of the piston except for the first end such that the piston won't be rubbed against the tube portion most of the time, and service life of the oil cylinder will be longer. However, the manufacturing cost of the oil cylinder is relatively high because the oil cylinder is complicated in the structure, consisting of an outwards projecting rod projecting from an end cap, a cover as well as a guiding rod next to the end cap, and a small piston secured to one end of the guiding rod and inserted in a bore of the outwards projecting rod. Furthermore, the mold closing oil cylinder will cause increase to the length of the whole molding machine significantly because it is fixed to the rear fixed wall, and in turns, the molding machine will occupy much space.

Referring to FIG. 10, U.S. Pat. No. 4,981,426 discloses an injection molding machine of horizontal type, which has a mold closing oil cylinder also disposed on a tail end of a rear fixed wall thereof. Therefore, the mold closing oil cylinder will cause increase to the length of the whole molding machine significantly. And, the oil cylinder is even more complicated than that of the last machine in structure, and not economical to use.

A common disadvantage of the pistons of the above oil cylinders is that there is relatively big difference between the exposed areas of both sides of each piston. Consequently, there will be unstable flow of hydraulic oil between one of two separate chambers of each cylinder tube portion and the other, and the oil cylinder can't function smoothly.

### SUMMARY OF THE INVENTION

It is a main object of the present invention to provide an injection molding machine to overcome the above disadvantages.

The injection molding machine includes a stationary wall for a first mold part to be secured thereto, a movable wall for a second mold part to be secured thereto, a heating tube opposing a first side of the stationary wall, and oil cylinders for displacing the movable wall relative to the stationary wall with. The oil cylinders are secured to the first side of the stationary wall at tube portions thereof with output rods thereof being projected from the other side of the stationary wall and connected to the movable wall; thus, there is no need for conventional guiding rods for the movable wall or rear fixed walls, and the machine is simpler in structure, and the whole machine is reduced in length. Each oil cylinder has a piston, and a subsidiary rod having substantially the same diameter as the output rods. The output rods are connected to first sides of the pistons; the subsidiary rods are connected to the other sides of the pistons and can pass through caps of the cylinder tube portions; thus, both sides of each piston have the same area.

### BRIEF DESCRIPTION OF THE DRAWINGS

The present invention will be better understood by referring to the accompanying drawings, wherein:

FIG. 1 is a vertical view of the injection molding machine according to the present invention,

FIG. 2 is a front view of the injection molding machine according to the present invention,

FIG. 3 is a partial enlarged view of the injection molding machine according to the present invention,

FIG. 4 is another partial enlarged view of the injection molding machine according to the present invention,

FIG. 5 is a vertical view of the injection molding machine of the present invention, in operation,

FIG. 6 is a front view of the injection molding machine of the present invention, in operation,

FIG. 7 is a view of the first conventional injection molding machine as described in the Background,

FIG. 8 is a view of the second conventional injection molding machine,

FIG. 9 is a view of the injection molding machine disclosed in U.S. Pat. No. 4,645,443, and

FIG. 10 is a view of the injection molding machine disclosed in U.S. Pat. No. 4,981,426.

### DETAILED DESCRIPTION OF THE PREFERRED EMBODIMENTS

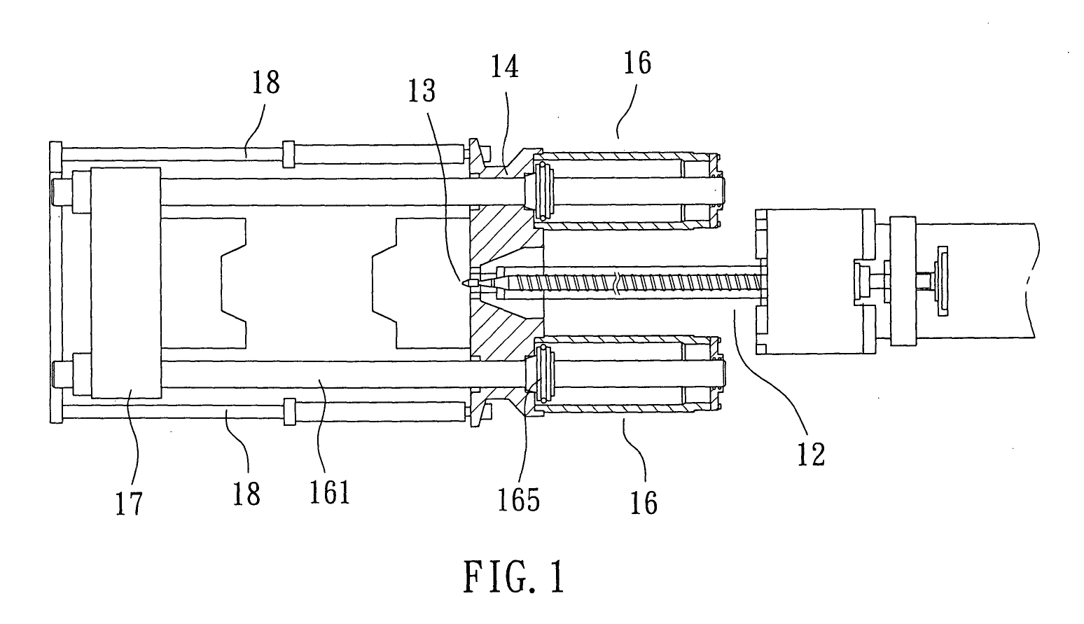

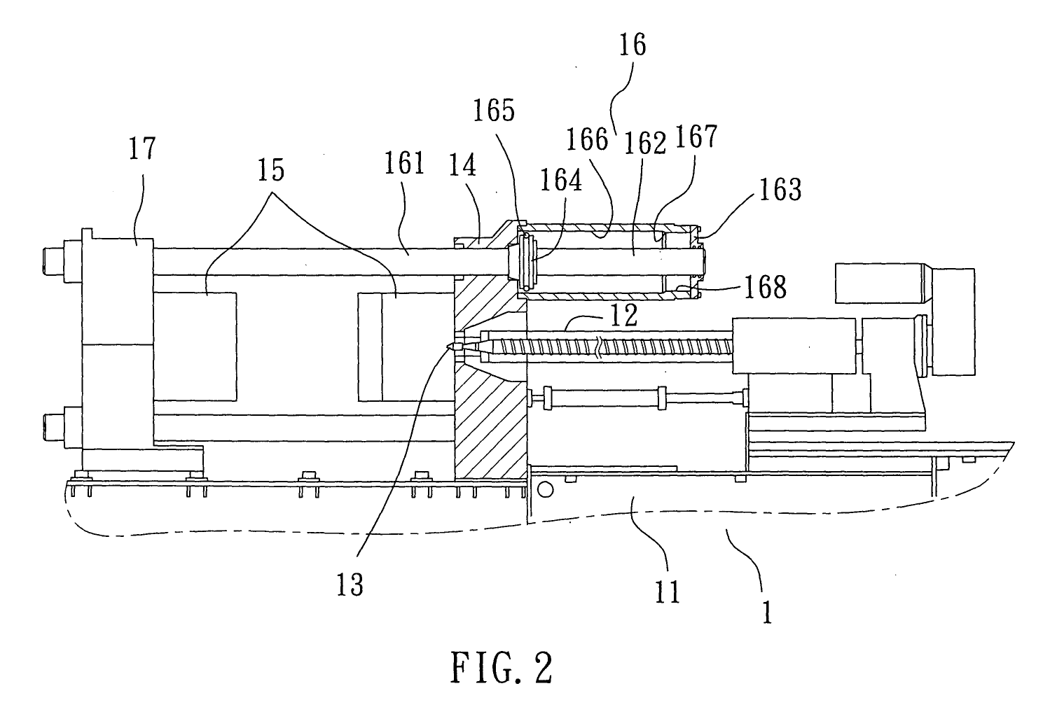

Referring to FIGS. 1, and 2, a preferred embodiment of an injection molding machine 1 in the present invention has a main support 11, a material feeding mechanism (not numbered) disposed on one end of the main support 11, a heating tube 12 connected to the material feeding mechanism, an injection nozzle 13 connected to a tail end of the heating tube 12, a stationary wall 14 on an intermediate portion of the main support 11, several main mold closing oil cylinders 16, several subsidiary oil cylinders 18, and a movable wall 17 opposing the stationary wall 14 on the other end of the main support 11; the stationary wall 14 has a hole (not numbered) for allowing the injection nozzle 13 to pass through; the walls 14 and 17 are provided for two parts of a mold 15 to be secured thereon respectively. Each of the main oil cylinders 16 is secured to the stationary wall 14 at a tube portion thereof with an output rod 161 thereof being passed through the stationary wall 14, which output rod 161 is connected to one side of a piston 164 of the oil cylinder 16. Each of the main oil cylinders 16 has a subsidiary projecting rod 162, which is connected to the other side of the piston 164, and which can pass through an end cap 163 of the oil cylinder tube portion when the oil cylinder 16 is functioning. Thus, the movable wall 17 can be moved for closing and opening the mold 15 by means of the oil cylinders 16 and 18.

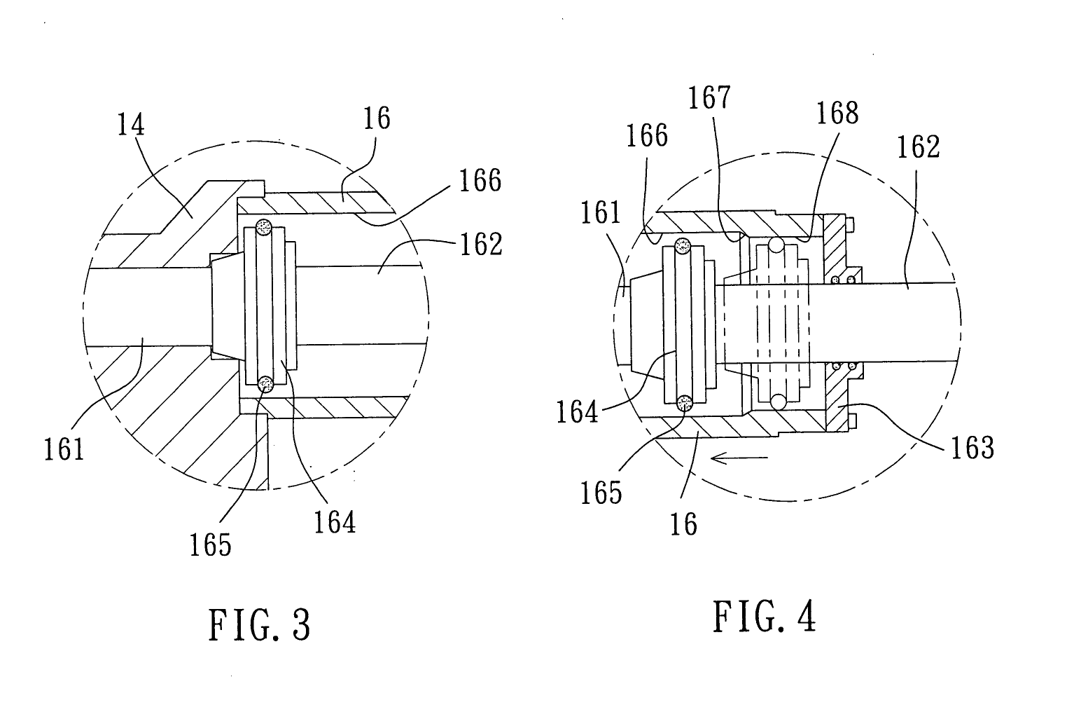

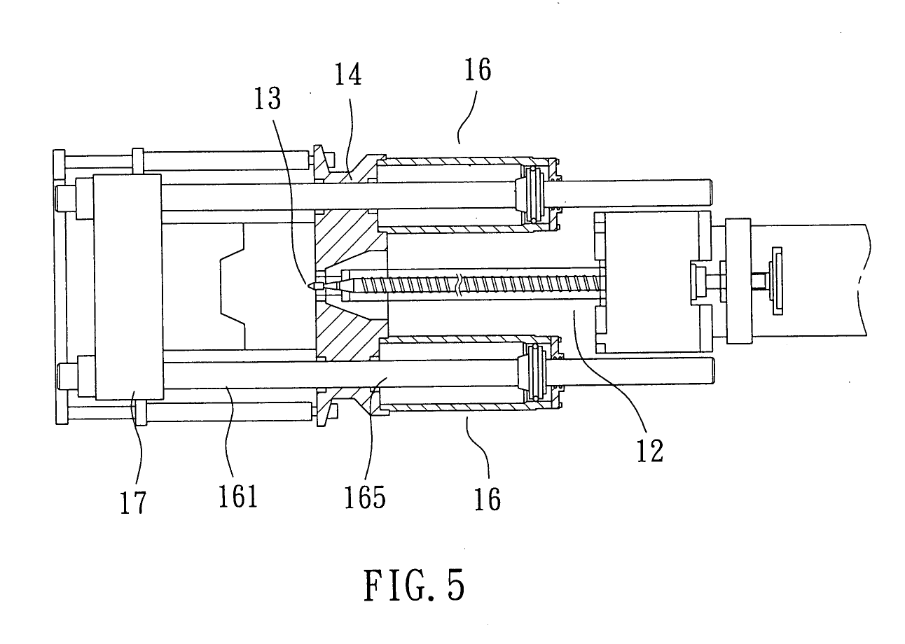

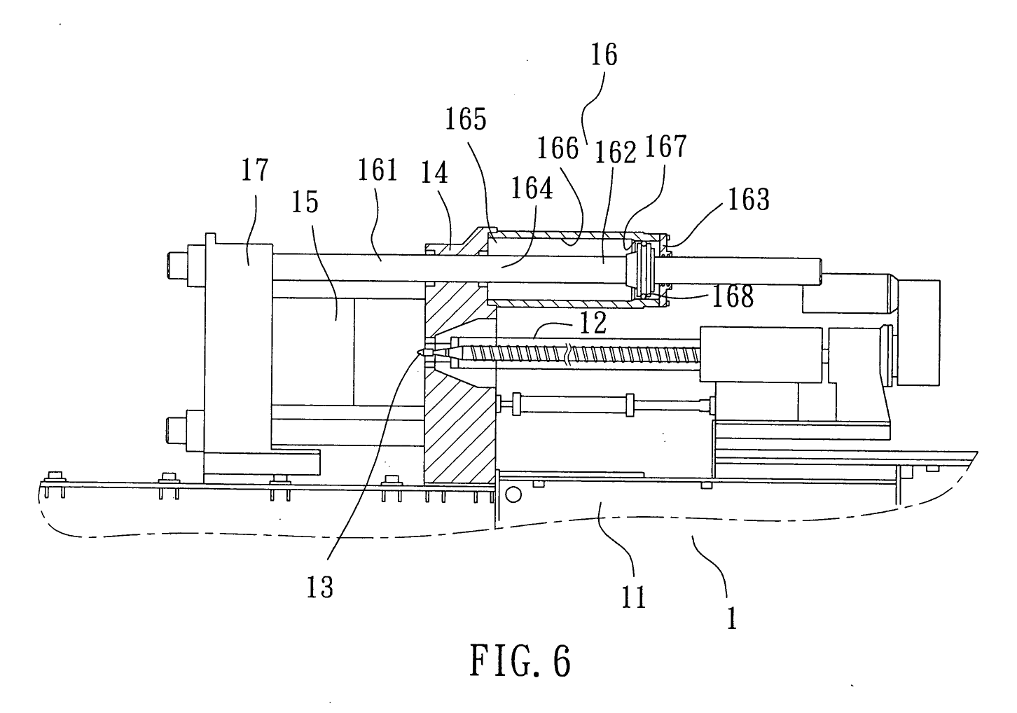

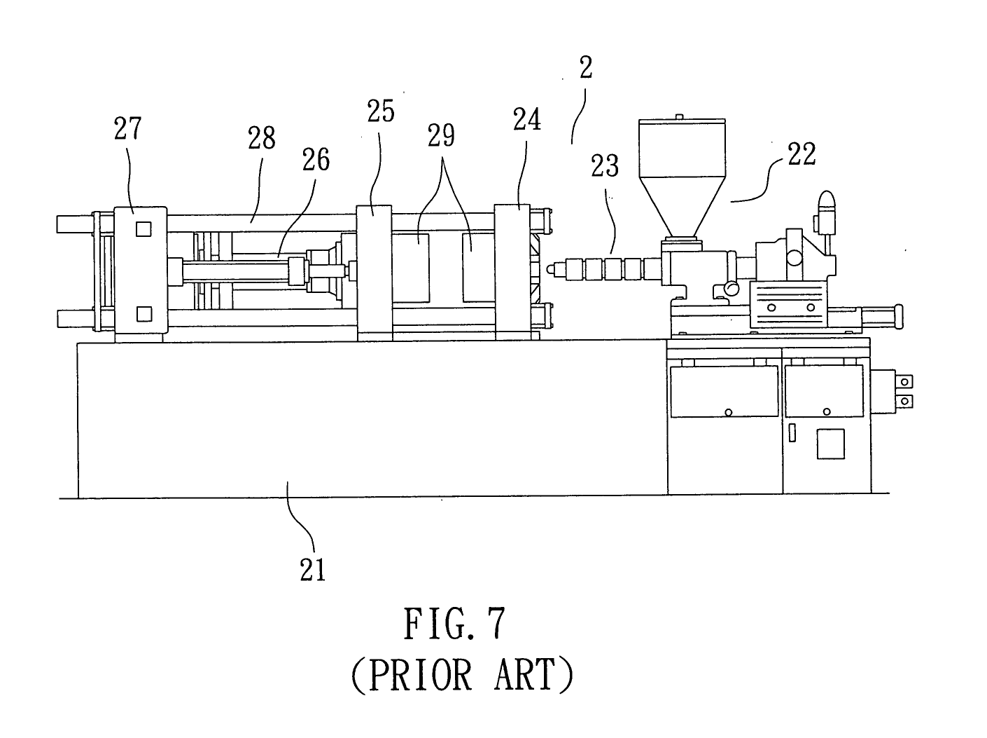

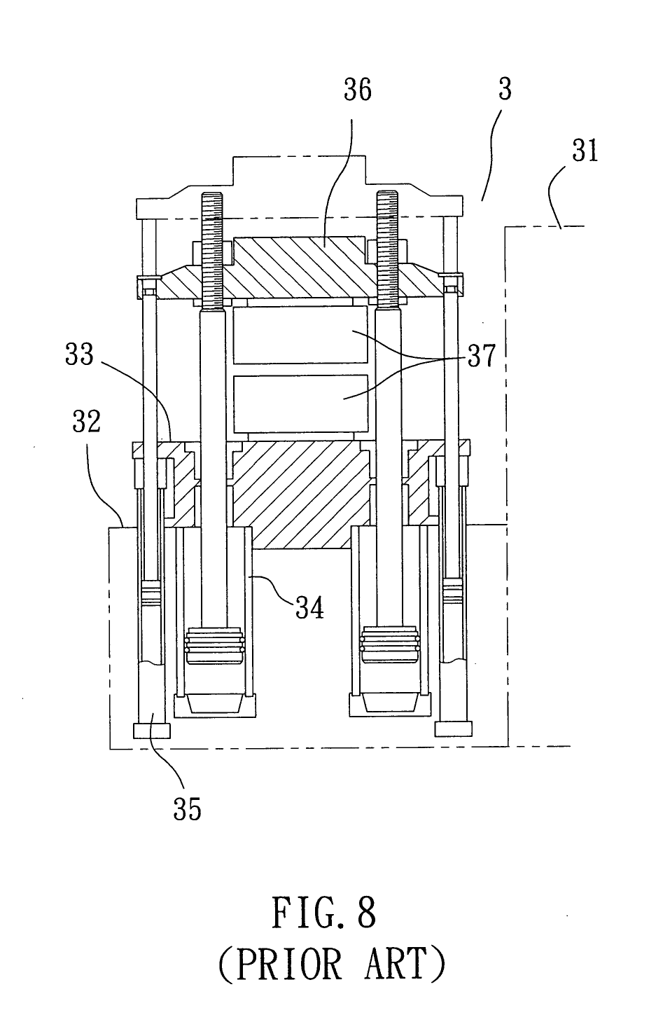

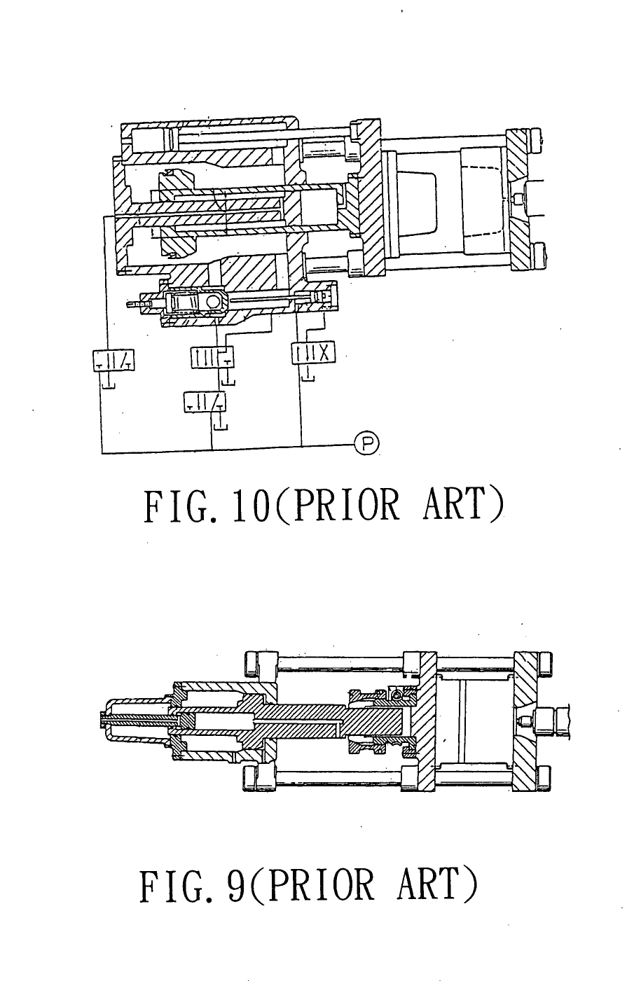

The piston 164 has a piston ring 165 disposed around it. The tube portion of each main oil cylinder 16 is formed such as to have an annular sloping portion 167 on an inner side between two ends, and a bore, which includes a first enlarged section 166, and a second section 168, which bore sections 166 and 168 are adjacent to the annular sloping portion 167; the second bore section 168 is smaller than the first bore section 168 in diameter. The piston rings 165 won't contact the walls around the first enlarged bore sections 166 of the oil cylinder tube portions when the pistons 164 are within the first bore sections 166, but they will be pressed against the walls around the second sections 168 with suitable tightness when the pistons 164 are passed into the second bore sections 168, as shown in FIG. 3. Thus, the piston rings 165 won't be rubbed against the cylinder tube portions when the pistons 164 are within the sections 166, and enough pressure is secured at the end of mold closing process for allowing the mold part on the movable wall 17 to be coupled to the mold part on the stationary wall 14, as shown in FIGS. 5 and 6.

The diameter of the output rods 161 of the oil cylinders 16 is substantially the same as that of the subsidiary projecting rods 162; thus, both sides of each of the pistons 164 have the same area.

From the above description, it can be understood that the injection molding machine of the present invention has, when compared with the conventional ones, advantages as followings:
1. The main oil cylinders 16 won't cause increase to the length of the whole molding machine because the tube portions thereof are disposed on that side of the stationary wall 14 that the heating tube 12 is faced with. Consequently, the molding machine will occupy less space.
2. The tube portions of the main oil cylinders 16 are disposed on one side of the stationary wall 14 with the output rods 161 being projected from the other side of the wall 14 and connected to the movable wall 17 at those positions where conventional guiding rods for movable wall can be inserted through instead. Therefore, there is no need for conventional guiding rods or other conventional mechanisms that are disposed next to the outward side of movable wall. Consequently, the injection molding machine is simpler in structure, and the whole machine is reduced in length.
3. Amounts of oils in both chambers of each tube portion that are separated by the piston 164 are substantially the same when the oil cylinder 16 is functioning because both sides of each of the pistons 164 have the same area due to the subsidiary projecting rod 162 connected to the piston 164. Consequently, the present oil hydraulic cylinders 16 will function more smoothly than the above conventional ones.

1. An improvement on an injection molding machine, comprising
a stationary wall fixedly disposed on a main support for a first half part of a mold to be secured thereto;
a movable wall for a second half part of the mold to be secured thereto; the movable wall being movable on the main support and opposing the stationary wall such that the second mold part can be coupled to the first mold part when the movable wall is close to the stationary one; and
a plurality of main oil cylinders for displacing the movable wall relative to the stationary wall with;
the main oil cylinders being secured to a first side of the stationary wall at tube portions thereof with output rods thereof being projected from other side of the stationary wall and connected to the movable wall to replace guiding rods for the movable wall; each of the main oil cylinders having a piston, and a subsidiary projecting rod; each piston having first and second sides; the output rods being connected to the first sides of the pistons; the subsidiary projecting rods being connected to the second sides of the pistons and capable of passing through end caps of the tube portions of the oil cylinders; the output rods having substantially same diameter as the subsidiary projecting rods.
